(19) United States
(12) Patent Application Publication
(10) Pub. No.: US 2010/0147089 A1
(43) Pub. Date: Jun. 17, 2010

(54) FORCE/ENERGY RE-VECTORING DEVICE

(75) Inventor: Denny D. Beasley, La Grange Park, IL (US)

Correspondence Address: UNGARETTI & HARRIS LLP;INTELLECTUAL PROPERTY GROUP - PATENTS, 70 WEST MADISON STREET, SUITE 3500, CHICAGO, IL, 60602-4224, US

(73) Assignee: ROBERTSON TRANSFORMER CO., Blue Island, IL (US)

(21) Appl. No.: 12/600,556

(22) PCT Filed: May 19, 2008
(86) PCT No.: PCT/US08/64101

§ 371 Date: Nov. 17, 2009

Related U.S. Application Data
(60) Provisional application No. 60/938,474, filed on May 17, 2007.

(51) Int. Cl. F03G 3/00; F16H 33/20

(52) U.S. Cl. 74/25

(57) ABSTRACT

Apparatus (10, 12, 14, 16, 18, 20) for conversion of a rotary drive force such as from a drive motor (22) into a vectored linear force m a known, controlled and predictable manner. The vectored linear force may be used for lifting/moving objects, pushing objects through water or into space. The vectored linear force is generated without the expulsion of mass or reaction with an external material or medium. As a consequence, the force generating apparatus may be embodied within an enclosed system having an energy source for generating the rotary drive force that can sourced from ordinary means such as an electrical generator, or from hydraulic or other mechanical sources.

### CROSS REFERENCE TO RELATED APPLICATIONS

The present application claims benefit of U.S. Provisional Application 60/938,474 entitled FORCE/ENERGY RE-VECTORING DEVICE, filed May 17, 2007 by Denny B. Beasley, the entirety of which is hereby incorporated herein in its entirety.

### FIELD OF THE INVENTION

The present invention relates to a force/energy re-vectoring device for the redirection of forces in a mechanical system.

### BACKGROUND OF THE INVENTION

Many different force generation systems are known within the scope of the prior art, and many different systems are known in the art for converting or re-vectoring forces within a force generation system.

For example, for ground propulsion, a propelled body is often mounted on wheels and subjected to an applied force. Such vehicles may be propelled manually, by a human or animal applying drive force to the vehicle relative to the earth, such as is the case in wagons, carts and wheelbarrows. Alternately, such vehicles may be propelled by the use of a force re-vectoring devices such as a transmission, piston and cylinder or other such systems. These systems allow ground propulsion by the application of linear or rotary drive force directly or indirectly to the wheels, as is the case in cars, bicycles and wheelchairs. In many cases, the propulsive mechanical force is generated by an engine that consumes an energy source carried within the vehicle. Common examples include a steam engine or internal combustion engine powered by combustion of fuel, an electric motor powered by electricity from a chemical battery and/or generated from an internal combustion or fuel cell, and others.

Marine propulsion is generally accomplished by the application of force upon the water and/or air surrounding the propelled vessel. Forces are typically generated by the use of paddles, oars, propellers or water jets which act upon by the water adjacent to the vessel. These methods typically require the conversion of a source of propulsion to a rotary torque applied to the propeller, or a linear force applied to the oar or paddle. Magnetohydrodynamic drives have been used to apply electromagnetic forces to the water adjacent to the vehicle. Sails and underwater foils have been used in sailing vessels to capture and re-direct wind and water current to generate desired net forces on a vessel.

Aircraft propulsion is generally accomplished by the application of force upon the air surrounding an aircraft. The most common mechanisms for applying such forces are the propeller, jet engine and turboprop. Each of these methods involves the use of moving parts (propellers or turbofans) which operate upon the air adjacent to the airship to generate drive, and which are driven by the combustion of fuel therein or in a separate engine (such as the internal combustion engine driving the propellers). Other air propulsion systems using fewer moving parts include the ramjet, scramjet, pulse jet, and pulse detonation engines, and the rocket engine.

Spacecraft propulsion presents the unique challenge that there is no surface, water or air surrounding a spacecraft to which force may be applied. Spacecraft propulsion is therefore typically accomplished by the use of rocket engines, which generate propulsion by exhausting a gas from the back/rear of the vehicle at very high speed, e.g., through a supersonic de Laval nozzle. Rocket engines require a propellant and oxidizer supply for operation in space (whether bipropellant or solid-fuel), although rocket engines that operate within Earth's atmosphere can use air in the atmosphere for combustion. Some spacecraft use momentum-carrying wheels for attitude control, and a number of spacecraft have used electric propulsion such as ion thrusters to generate forces. Solar sails have also been proposed as a means to obtain spacecraft propulsion from sun or starlight.

### SUMMARY OF THE INVENTION

The present invention relates to a force re-vectoring device. The device creates a repulsive reaction between two relatively moving bodies, such as a rotor and stator. Through the redirection of the relative motion of one of those bodies, a vectored linear force is produced on the system, in a known, controlled and predictable manner. The vectored linear force may be used for lifting/moving objects on the ground or through water, pushing objects on the ground or through water, or moving objects in/into space. The vectored linear force is generated without the expulsion of mass or reaction with an external material or medium. As a consequence, the force generating apparatus may be embodied within an enclosed system having an energy source for generating the rotary drive force that can sourced from ordinary means such as an electrical generator, or from hydraulic or other mechanical sources.

In the specific aspects described below, the apparatus uses a first reactive mass and a mechanical system for applying force to the first reactive mass to cause motion of the first reactive mass along an initial path of motion relative to the closed system (such as a rotary path). The mechanical system permitting deflection of the first reactive mass from its initial path of motion, so that when a repulsive force (such as a magnetic force) is applied to the first reactive mass, there is a deflection of the first reactive mass from its initial path of motion. The mechanical system then applies a restoring force to the reactive mass to return it to its initial path of motion and in the process produces the vectored force from the combination of said repulsive and restoring forces.

In the detailed embodiment described, the mechanical system is a rotor with a hinge located between the rotor's hub and the first reactive mass, so that bending of said hinge permits reduction of the rotary moment of inertia of the first reactive mass.

Further aspects include the method for re-directing forces described above and in the detailed description below, and a closed system apparatus that generates a vectored force upon itself using the structures described.

The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is an illustration of two masses interacting subject to Newton's Third Law;

FIG. 2 is an illustration of the proportionate kinetic energy delivered to unequal masses when a repulsive force is applied between those two masses;

FIGS. 3A and 3B are plan and side views of a device in accordance with principles of the present invention;

FIG. 4 is a detail view of FIG. 3B showing the interaction of a rotor arm, rotor magnet and pole piece;

FIG. 5 is an illustration of two alternative motion patterns characteristic of different resonant conditions of the device illustrated in FIGS. 3A, 3B and 4, and FIG. 5B is a side view of the rotor arm motions characteristic of these two resonant conditions;

FIG. 6 is an illustration of the angular profile of the magnetic field generated by the stator in one embodiment of the present invention;

FIG. 7 is an illustration of the output of a piezoelectric strain gauge, and the integral thereof, when supporting the weight of an non-operating device such as shown in FIGS. 3A, 3B and 4;

FIG. 8 is an illustration of the output of the piezoelectric strain gauge and the integral thereof when the device is activated and generating a generally vertically upward force;

FIG. 9 is an illustration of the output of the piezoelectric strain gauge and the integral thereof when the device is inverted relative to FIG. 8, and generating a generally vertically downward force;

FIG. 10 is an illustration of the strain gauge output and integral thereof over an expanded time scale;

FIG. 11 is an illustration of the strain gauge output and integral thereof at a rotor frequency away from the primary resonance frequency.

### DETAILED DESCRIPTION OF SPECIFIC EMBODIMENTS

The present invention utilizes well-known principles of force and momentum to displace the reactionary forces of a closed system in such a manner as to provide a net vectored force of a known direction that can do work.

It is well known that repulsive reactions between objects of unequal mass, distribute unequal energy to the two masses. Consider as an example, the recoil when firing a rifle: the rifle acquires very little of the energy in the bullet-rifle-powder system. If the energy transfer were, as intuition may seem to prescribe, equal energies to the rifle and the bullet, the shooter would receive the same transfer of energy as the target, with equal destructive power.

There is a nonlinear relationship between the energy received by bodies of unequal mass, as demonstrable from well-known equations of conservation of energy. In an elastic collision of two masses or a repulsive reaction between two masses (such as from a spring, expanding gas or magnetic repulsion), equal and opposite forces act each mass. The energy absorbed by each body from those forces is inversely proportional to its mass.

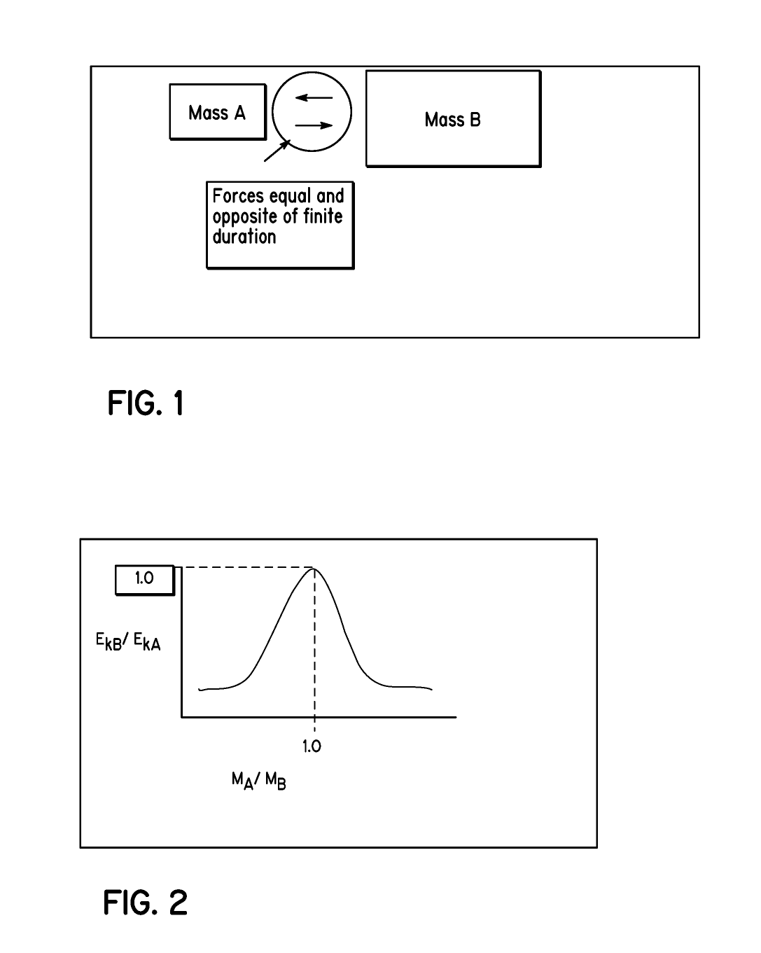

Referring to FIG. 1, one can see a Mass A and a Mass B, acted on by equal but opposite forces. The application of this force over time imparts a finite energy to each mass. To determine the energy imparted to each mass, one may compute as follows:

From the equation for kinetic energy E=½ MV² and:

If E_{kA}=kinetic energy Mass A and E_{kB}=kinetic energy Mass B

Then proportion of ratio of energy transfer is;

E_{kB}/E_{kA}=4(M_{A}/M_{B})/(1+M_{A}/M_{B})²

FIG. 2 illustrates the curve relating the proportionate energy transfer E_{kB}/E_{kA} to the proportionate mass M_{A}/M_{B}. Physics demonstrations often illustrate energy transfer using a “Newton's Cradle” pendulum set, with a series of equal masses. When a mass is swung into the set at one side, the energy is transferred to an equivalent swing at the opposite side. Using this backdrop of equal masses, the nonlinearity in energy transfer may be demonstrated using a similar pendulum set, with progressively dissimilar masses. When a small mass at one end is swung into and impacts on the next larger mass it creates a series of interactions of nearly equal masses, each accomplishing nearly complete energy transfer, so that on the opposite end the largest mass receives the transferred energy and swings out proportionally to the received energy transfer. However, if one remove the intermediate masses and swings the smallest mass to directly impact on the largest mass, very little energy is transferred to the largest mass and it moves very little.

The present invention uses this effect of fractional energy transfer between highly dissimilar masses, in an arrangement that also creates unbalanced repulsive and restorative forces. The resulting closed system creates an unbalanced vectored force on the system as a whole.

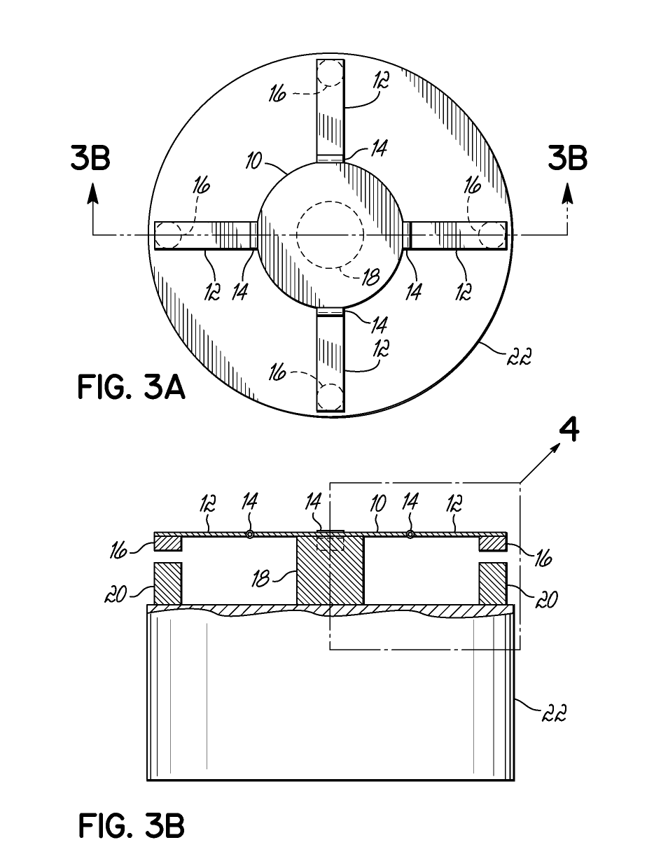

FIGS. 3A and 3B are schematic views of one possible configuration of an apparatus in accordance with principles of the present invention. In this system, a rotor 10 carries a number of rotor arms 12 (four such arms in the illustrated embodiment). Each arm 12 has a hinge 14 along its length, and carries at its radially outward end a permanent magnet 16. The rotor 10 is rotated by a motor 18 at a controllable speed. Stationary magnets 20 are positioned to react with the magnets 16 on the rotary arms 12. The stationary magnets form magnetic poles which repel the pole of the magnets 16 on the rotary arms, thus creating repulsive reactions between a poles 20 and a magnet 16 as the magnet is rotated by rotor 10.

It will be noted that the hinges 14 permit movement of the magnets 16 and the hinged portion of the arm 12 upwardly relative to the stator. The magnet 16 along with the hinged portion of the arm 12 forms what will be identified as a rotor “petal”, having a first mass. The stator and the entirety of the apparatus other than the rotor, forms a second mass that interacts with the first mass upon magnetic repulsion. This magnetic repulsion delivers the majority of the resulting kinetic energy to the magnet 16 and hinged portion of the arm as these are the smaller mass.

It will be noted that the rotor petal, comprising the magnet 16 and hinged part of the arm 12, has an inertial moment about the center of the rotor 10, and this inertial moment is reduced when the repulsive reaction of magnet 16 with magnet 20 causes magnet 16 to move upward on the hinge 14.

FIG. 3 illustrates just one configuration of one possible arrangement of the present invention. The invention need not utilize a rotary assembly, and need not utilize a balanced arrangement of attached arms. Electromagnets or other sources of repulsive force can be used such as expanding gasses or light forces (laser pulses). Furthermore, the device need not incorporate a mechanical hinge; all that is needed is a mechanism that permits movement of the rotary mass in a way that reduces the angular moment of inertia of the rotary mass in response to a repulsive reaction with the stator.

Operation of the device of FIG. 3 begins with the rotor coming to speed. The magnets 16 all have the magnetic vectors or poles in a common direction to provide a repulsive force with the reactionary pole pieces 20 (north to north or south to south).

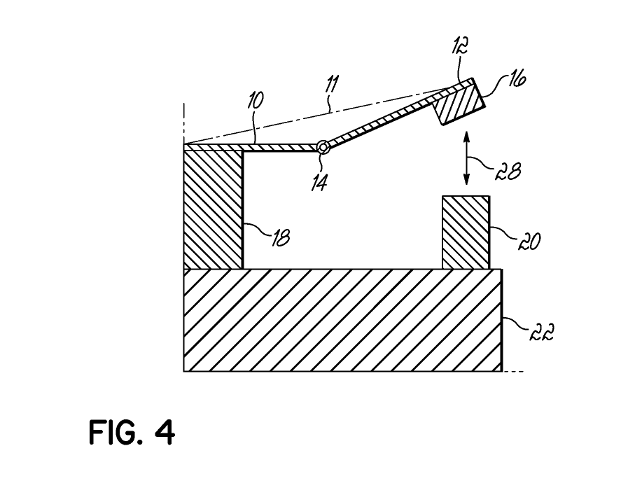

As illustrated in FIG. 4, a motor 22 applies a driving force to a motor shaft 18 to rotate the rotor 10 at a desired speed. During rotation, when permanent magnet 16 approaches the reactionary pole piece 20, a repulsive force 28 is exerted that causes the petal 11 of rotary arm 12 to move orthogonal to the rotary plane of the rotary hub 10. As in the recoil reaction of the masses A and B of FIG. 1, little energy is transferred to the more massive motor assembly to which the reactionary pole piece 20 is attached. Therefore the petal 11 of the rotary arm is deflected from its horizontal position, at the greatest radius and greatest inertial moment, to a position of shorter radius, in proportion to the energy loss from the repulsive force 28 pushing the rotary arm from its horizontal position. (Although the rotor is described as lying in a horizontal plane, with the motor shaft on a vertical axis, this is a convenience of explanation and is irrelevant to operation of the invention.)

As the permanent magnet 16 attached to rotary arm 12 moves away from the reaction pole 20 it is above but in the same rotary direction, in a parallel plane above the native horizontal. This deflection reduces the moment of inertia of the magnet 16 and arm, due to the reduced distance of the mass from the rotational axis. The reduction is proportional to the energy extraction by repulsive force caused when the reaction pole 20 is within effective reactionary proximity to permanent magnet 16.

Once in this reduced energy state, the petal 11 of the rotary arm extracts energy in the form of torque applied by the motor 22 via the motor shaft 18, to recover its angular momentum and return to its native horizontal position.

In accordance with the foregoing, it will be appreciated that there are two different means to move energy into and out of the mass of the rotary arm petal 11. The first is the repulsive reaction of the same polarity magnets 16 and 20 on the rotary arm and reaction pole. The second, is rotational energy that is replaced via the motor, via an increase in the motor torque demand. Furthermore, it will be appreciated that the forces generated during the repulsive interaction are different in kind and direction than those generated during the recovery interaction. Thus an asymmetry can be created to allow the unbalanced force condition.

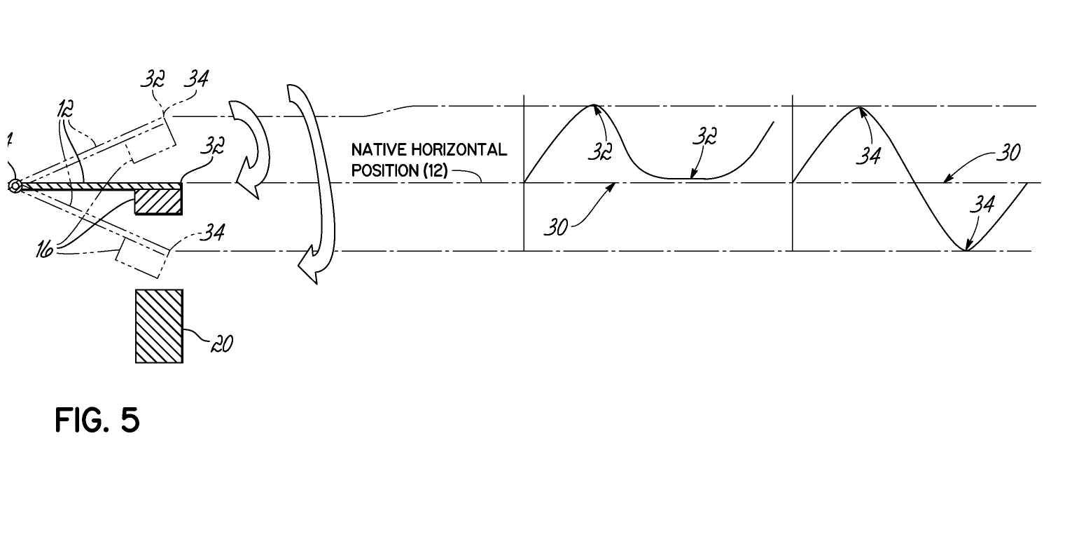

It will be noted that the reaction between the magnet 16 and a magnet 20 occurs periodically. As illustrated in FIG. 5, the periodic reactions may occur with a number of possible frequencies depending upon the relative rotational speed of the rotor, strength of the magnets and the relative mass of the arm petal 11 and magnet 16.

It has been determined through experimentation that a resonant state can be created in which the reaction between the magnet 16 and the next pole piece 20 occurs before the rotary arm petal 11 passes through its native horizontal position, and a resonant state can be created in which the rotary arm petal 11 oscillates equally between displacements above and below its native horizontal position. These two alternate forms of resonant oscillation are illustrated in FIG. 5, which shows the native horizontal position 30 and the arm motions 32 and 34 characteristic of the first and second resonances.

Experimentation has shown that the first form of resonance, identified at 32 in FIG. 5, will generate a net force on the stator/rotor/motor system, directed from the stator toward the rotor. This force is believed to result from the differential in the imparted displacement energy applied during the deflective force/recovery cycle. The reason for the force imbalance is that the repulsive magnetic reaction between two unequal masses caused the smaller mass petal 11 (arm 12/magnet 16) to absorb the most energy in the form of linear motion and reduced angular momentum. The recovery of the induced deflection occurs by the delivery of torque to the rotor and by a linear force between the rotor hub 10 relative to the arm petal 11 as the deflected petal's mass recovers lost energy and returns to its initial horizontal condition.

The next reaction cycle must occur just at or before the deflected mass crosses the native horizontal plane 30 to dampen out the acquired inertial energy as the rotary arm petal 11 recovers to its initial/native position 30. Failure to do so will allow the rotor to balance out the recovery energy in an oscillator condition similar to a pendulum.

The above actions create a phased inertial wave where the energy is passed by repulsive reaction, and then recovered by rotary acceleration. The two conditions are orthogonal to one another and therefore do not cancel one another, thus leading to a net angular force applied to the rotor within the closed system and a net vectored force rectified from that angular force and directed upon the closed system as a whole, and capable of doing work on that closed system.

In FIG. 5 is the graphical and physical representation of two transitional states 32 and 34. Transition 32 is the ideal state whereby the reaction dampens the excess recovery energy acquired to move the rotary arm petals 11 back to the native horizontal position 30. Failure to do so will allow transition 34 to occur and create a mirror image of the recovery transition and thereby provide no net force.

Experimental results have indicated the force generated can be controlled by phasing the repulsive reaction relative to transitional state condition of the rotary arm. This is similar to the intermediate masses in the physics experiment described previously. One action imparts an energy loss that is disproportional between the reactionary masses, however in the recovery cycle, the lost energy is replaced asymmetrically by a different mechanism and therefore unbalanced. Thus a vectored force is created capable of delivering a quantity of vectored energy, through a force acting on the closed system, but opposite in direction the initial deflection of the rotary arm petal 11.

In the above examples the repulsive reaction used magnet means to generate the repulsive force 28. The repulsive could be generated by many means and is not limited to magnetic, nor directly related to magnetic forces—it could be electrostatic or expanding gases generating the reactionary forces.

To enhance the operation of the described device, the intra discharge-pole space is interspersed with an MMF distribution that is substantially sinusoidal in nature. This is most important in devices with an even number of discharge poles. The methods of Fourier, as it applied to complex waves, provide one conceptual way to understand device operation. Specifically, if one considers an inertial standing wave reacting with a stationary MMF wave along the perimeter as shown in the attached figure. If the stationary wave is square, as is the dynamic inertial wave, then the possibility of odd harmonics can lead to interactions that are counter to the intended effect. It is therefore important to configure the mechanical system to minimize these effects.

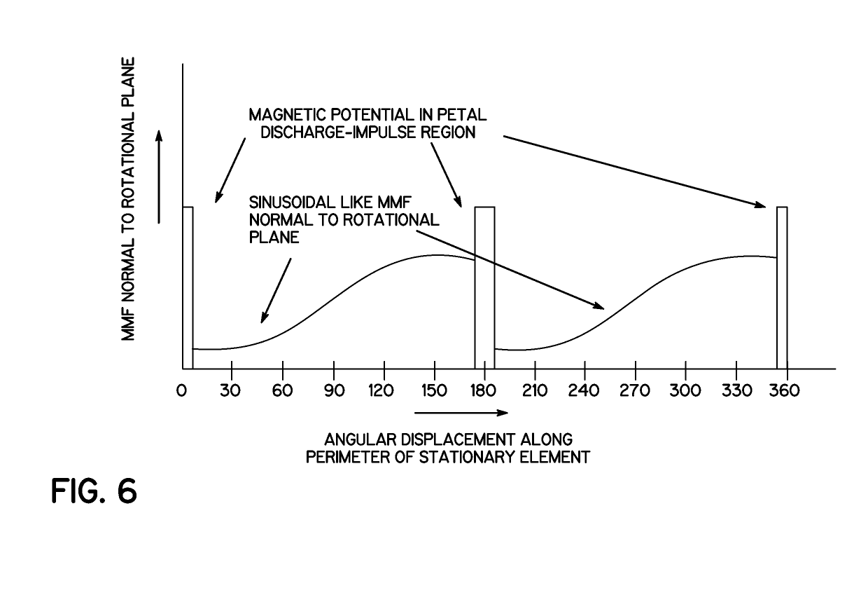

FIG. 6 illustrates one approach to profiling the MMF profile at various angular locations around the periphery of the stator, in a way that can help minimize odd harmonics. The MMF profile is substantially sinusoidal in nature; the more sinusoidal the established standing inertial wave—the less likely counter productive harmonics could negatively impact operation. The MMF axis in the FIG. 6 graph, is the MMF component normal to the plane of rotation of the rotor. The MMF distribution is however three dimensional and should be more substantial toward the rotor shaft and below the rotor petals 11 so as to provide the greatest strength of reaction with the petal reaction means.

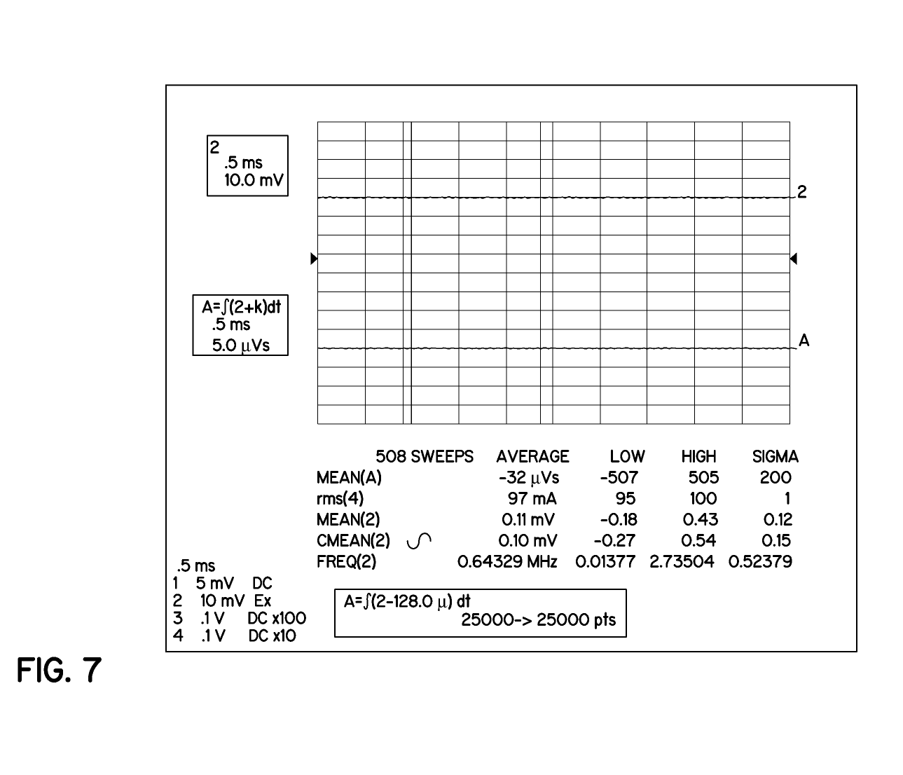

FIGS. 7-11 illustrate experimental results with a device such as described above. FIG. 7 illustrates the output signal generated by a piezoelectric strain gauge (trace 2), when a device in accordance with the present invention is hung from a support via the strain gauge, so that the strain gauge measures the net downward force on the device. When the device is not operating, the force measured by the strain gauge is a constant tare value as seen on oscilloscope trace 2. The oscilloscope also measures the integral over time of the force measured by the strain gauge relative to this tare point on oscilloscope trace A. This trace also reads a steady zero value.

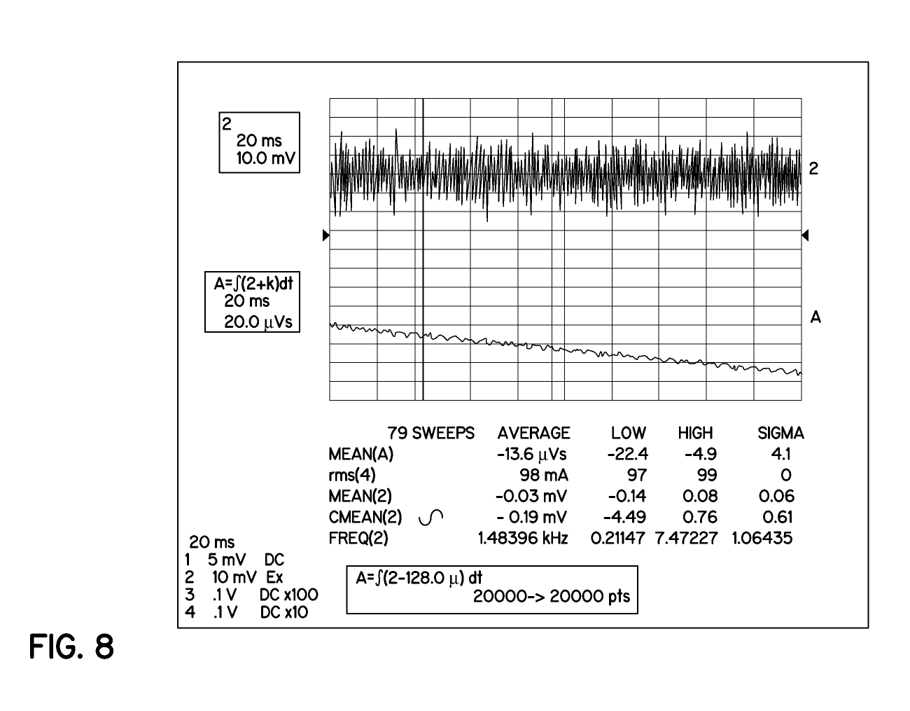

FIG. 8 illustrates traces 2 and A when the device is operative and oriented such that it generates a net upward force (opposing gravity). In this case it can be seen that an oscillatory force is measured by the strain gauge 2, which oscillation has a net negative component (the device-generated force opposes gravity producing a negative offset from tare). As a consequence the integral of the force relative to the tare point ramps negative over the entire sampling time of 1.6 seconds.

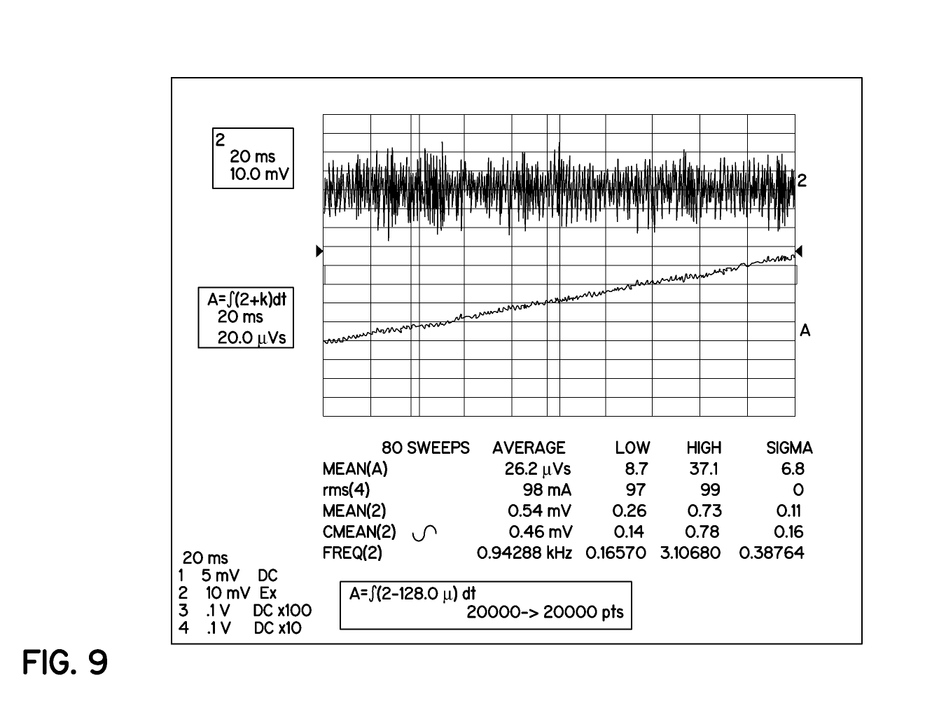

FIG. 9 illustrates traces 2 and A when the device is operative and oriented such that it generates a net downward force (aiding gravity). In this case it can be seen that an oscillatory force is measured by the strain gauge 2, which oscillation has a net positive component (the device-generated force reinforces gravity producing a positive offset from tare). As a consequence the integral of the force relative to the tare point ramps positive over the entire sampling time of 1.6 seconds.

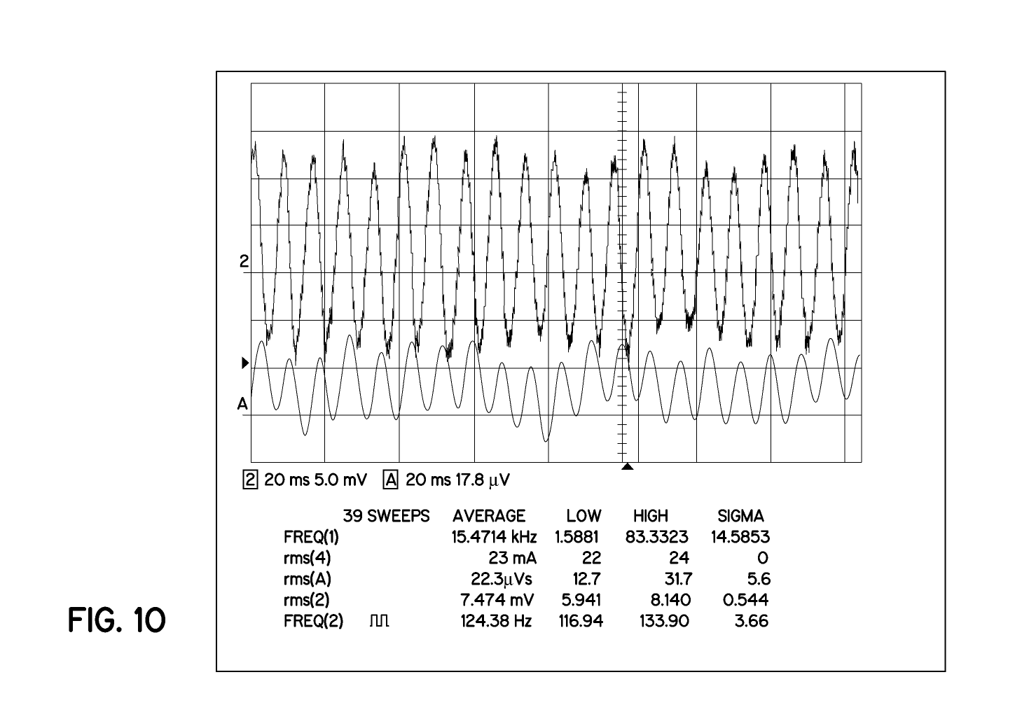

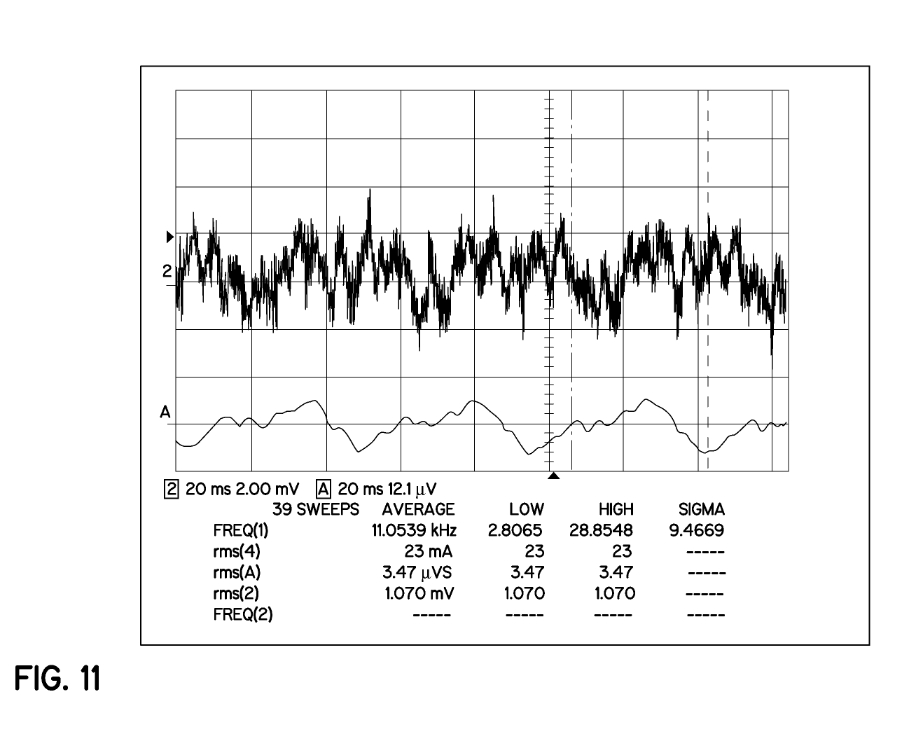

FIG. 10 is an illustration of traces 2 and A in the operative conditions of FIG. 9 over an expanded time scale. The oscillation of the measured force and the integral thereof can be seen. Notably, the force oscillation clearly has a positive offset relative to the tare point.

FIG. 11 is an illustration of traces 2 and A in the case where the rotational speed of the device is adjusted to cause breakdown of the primary resonance. In this case, as discussed above with respect to FIG. 5, no net force is seen in the measured force in trace 2 or in the integral thereof in trace A.

The present invention thus provides a device which, as explained in the summary, generates force within a closed system, so that the closed system may utilize energy from an internal energy source to produce a force upon the closed system capable of doing work.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. An apparatus for re-directing forces within a closed system to produce a vectored force to that system, the apparatus comprising:
a first reactive mass and a mechanical system for applying force to said first reactive mass to cause motion of said first reactive mass along an initial path of motion relative to the closed system, the mechanical system permitting deflection of the first reactive mass from its initial path of motion,
a second reactive mass,
a source of repulsive force for applying a repulsive force between said first and second reactive masses to cause deflection of the first reactive mass from its initial path of motion relative to said closed system,
the mechanical system applying a restoring force to said apparatus relative to said first reactive mass to return said first reactive mass to said initial path of motion following deflection due to said repulsive force, the restoring force displaced in orientation relative to said repulsive force so as to produce said vectored force from the combination of said repulsive and restoring forces.

2. The apparatus of claim 1 wherein the mechanical system comprises a rotor and a rotary drive for causing rotation of said rotor on a hub relative to the apparatus, the first reactive mass being a part of said rotor distal from the hub which has a rotary moment of inertia during rotation of said rotor.

3. The apparatus of claim 2 wherein the rotor further comprises a hinge located between said hub and said first reactive mass, bending of said hinge permitting reduction of the rotary moment of inertia of said first reactive mass.

4. The apparatus of claim 3 wherein the hinge comprises one or more of a rotary bearing and a flexible material permitting bending.

5. The apparatus of claim 3 wherein the second reactive mass comprises that portion of the apparatus excluding the first reactive mass, such that the second reactive mass is substantially larger than the first reactive mass and a greater portion of the energy from said repulsive force is delivered to said first reactive mass.

6. The apparatus of claim 3 wherein the second reactive mass comprises a pole piece mounted to said apparatus in proximity to the rotary path of said first reactive mass.

7. The apparatus of claim 1 wherein the source of repulsive force comprises opposed magnetic poles on said first reactive mass and said pole piece.

8. The apparatus of claim 7 wherein said opposed magnetic poles are formed from permanent magnets.

9. The apparatus of claim 7 wherein said opposed magnetic poles are formed from electromagnets.

10. The apparatus of claim 1 wherein the source of repulsive force comprises an expanding gas source.

11. The apparatus of claim 1 wherein the source of repulsive force comprises a light energy burst.

12. A method for re-directing forces within a closed system to produce a vectored force to that system, the method comprising:
directing a first reactive mass along a initial path of motion relative to the closed system,
applying a repulsive force between said first reactive mass and a second mass included within the closed system, to deflect the first reactive mass from its initial path of motion relative to the closed system,
applying a restoring force to said first reactive mass to return said first reactive mass to said initial path of motion following deflection due to said repulsive force, the restoring force displaced in orientation relative to said repulsive force so as to produce said vectored force from the combination of said repulsive and restoring forces.

13. A closed system apparatus for generating a vectored force to that system, the apparatus comprising:
a rotary drive,
a rotor driven by said rotary drive for causing rotation of said rotor on a hub relative to the apparatus, the rotor comprising a movable portion distal from the hub having a rotary moment of inertia, the movable portion having a first magnetic pole, and movably mounted to the rotor to change in the rotary moment of inertia thereof as a result of movement,
a stator positioned adjacent to said rotor, the stator including a second magnetic pole for applying a repulsive force to the first magnetic pole upon rotation of said first magnetic pole past said second magnetic pole, said repulsive force causing movement of said movable portion and reduction of rotary moment of inertia of said rotor,
whereby cyclical movements of said movable portion between positions of differing rotary moment of inertia generate unbalanced deflecting and restoring forces on said closed system so as to produce said vectored force from the combination of said deflecting and restoring forces.

14. The apparatus of claim 13 wherein said opposed magnetic poles are formed from permanent magnets.

15. The apparatus of claim 13 wherein said opposed magnetic poles are formed from electromagnets.

16. The apparatus of claim 13 wherein the rotary drive comprises one or more of an electric motor, an internal combustion engine, and a heat engine.
